(19) United States
(12) Patent Application Publication
(10) Pub. No.: US 2005/0234937 A1
(43) Pub. Date: Oct. 20, 2005

(54) System and method for rating performance of computing grid service providers

(75) Inventors: Leslie Mark Ernest, Knoxville, MD (US); Rick Allen Hamilton II, Charlottsville, VA (US); William Louis Moraca JR., McLean, VA (US); James Wesley Seaman, Falls Church, VA (US)

Correspondence Address: IBM CORPORATION (RHF), C/O ROBERT H. FRANTZ, P. O. BOX 23324, OKLAHOMA CITY, OK, 73123, US

(73) Assignee: International Business Machines Corporation, Armonk, NY (US)

(21) Appl. No.: 10/824,808

(22) Filed: Apr. 15, 2004

(51) Int. Cl. G06F 17/00

(52) U.S. Cl. 707/100

(57) ABSTRACT

The performance of one or more resource vendors in a grid computing environment are automatically rated by receiving one or more resource self-reports, a set of client-driven performance criteria, and job results from a grid resource. Rating logic performs an analysis of the job results against the client-driven performance criteria and the self-reports, and produces a grid resource rating table which allows for future selection of grid resources to be performed based upon actual historical performance of the available resources and vendors.

### BACKGROUND OF THE INVENTION

1. Field of the Invention

This invention relates to arts for dynamic management of networked computing resources, and especially to technologies for grid computing.

2. Description of the Related Art

In the 1990's, the communications standardization between wide ranges of systems propelled the Internet explosion. Based upon the concept of resource sharing, the latest evolutionary technology is grid computing.

Grid computing is an emerging technology that utilizes a collection of systems and resources to deliver qualities of services. It is distributed computing at its best, by creating a virtual self-managing computer, the processing for which is handled by a collection of interconnected heterogeneous systems sharing different combinations of resources. In simple terms, grid computing is about getting computers to work together, and allowing businesses, or grid participants, to optimize available resources.

The framework to grid computing is large scale resource sharing, which exist within multiple management domains, typically involving highly parrallelized applications connected together through a communications medium, and organized to perform one or more requested jobs simultaneously. Each grid resource's characteristics can include, but are not limited, to processing speed, storage capability, licensing rights, and types of applications available.

Grid computing's architecture is defined in the Open Grid Services Architecture (“OGSA”), which includes a basic specification Open Grid Services Infrastructure (“OGSI”).

Using grid computing to handle computing jobs of all sizes, and especially larger jobs such as enterprise processes, has several advantages. First, it exploits underutilized resources on the grid. For example, if a financial services company suddenly encounters a 50% increase in stock trade transactions during a 30-minute time period, using a traditional systems process, the company would face an increase in network traffic, latent response and completion time, bottleneck in processing and even overload on its resources due to its limited or fixed computational and communications resources.

In a similar situation, however, grid computing can adjust dynamically to meet the changing business needs, and respond instantly to stock transaction increase using its network of unused resources. For example, a grid computing system could run an existing stock trading application on four underutilized machines to process transactions, and deliver results four times faster than the traditional computing architecture. Thus, grid computing provides a better balance in resource utilization and enables the potential for massive parallel CPU capacity.

Second, because of its standards, grid computing enables and simplifies collaboration among many resources and organizations from a variety of vendors and operators. For instance, genome research companies can use grid computing to process, cleanse, cross-tabulate and compare massive amounts of data, with the jobs being handled by a variety of computer types, operating systems, and programming languages. By allowing the files or databases to span across many systems, data transfer rates can be improved using striping techniques that lead to faster processing giving the companies a competitive edge in the marketplace.

Third, grid computing provides sharing capabilities that extends to additional equipment, software, services, licenses and others. These virtual resources provide uniform interoperability among heterogeneous grid participants. Each grid resource may have certain features, functionalities and limitations. For example, a particular data mining job may be able to run on a DB2 server, but may not compatible to be processed on an Oracle server. So, the grid computing architecture selects a resource which is capable of handling each specific job.

Fourth, the grid can offer more advanced resource load balancing. A relatively idle machine may receive an unexpected peak job, or if the grid is fully utilized, priorities may be assigned to better execute the number of requested jobs. By using a Grid Management System (“GMS”) scheduler, a grid can provides excellent infrastructure for brokering resources.

International Business Machines (“IBM”) has pioneered the definition and implementation of grid computing systems. According to the IBM architecture, Service Level Agreements (“SLAs”) are contracts which specify a set of client-driven criterion directing acceptable execution parameters for computational jobs handled by the grid. SLA parameters may consist of metrics such as execution and response time, results accuracy, job cost, and storage and network requirements. Typically, after job completion, an asynchronous process which is frequently manual is performed to compare actual completion. In other words, companies use SLAs to ensure all accounting specifics such as costs incurred and credits obtained conforms to the brokered agreements.

The relationship between a submitting client and grid service provider is that of a buyer (client) and a seller (grid vendor). Currently, there are some public domains for clients to manually rate vendors based on past performances. However, these ratings are more subjective than objective, and rating criteria differs from each vendor. Furthermore, rating systems that have no consistent guidelines often produce accidental or purposeful skewing of results. Therefore, ambiguity, overrating or underrating often occurs.

Because current grid computing resource selection and scheduling processes do not have access to the results of the SLA compliance analysis or manually-created rating results, automated processes to fully utilize compliant resources, and to avoid use of non-compliant resources or historically under-performing resources to improve resource allocation and utilization is not possible. In addition, improved compliance with client requirements is difficult to ensure, and the SLA compliance analysis process remains manual, requiring tedious repetitive verifications to ensure contracts are met and customer requirements fulfilled.

Therefore, there exists a need in the art for a means to automatically and consistently rate the performance of grid computing resources, to facilitate better selection and scheduling of grid resources and jobs assigned to those resources, and to ensure compliance with client-driven performance requirements such as Service Level Agreements.

### DESCRIPTION OF THE DRAWINGS

The following detailed description when taken in conjunction with the figures presented herein present a complete description of the present invention.

FIG. 1 illustrates the logical process of the preferred embodiment.

FIG. 2 depicts our Grid Vendor Rating Report produced by our invention.

FIG. 3 provides details of how grid computing functions are accomplished.

FIG. 4 illustrates functionality for selecting a grid resource.

FIG. 5 shows a high-level view of grid computing in general.

FIG. 6 provides details of the logic of the present invention for producing and using a grid vendor rating table.

FIG. 7 depicts a generalized computing platform, suitable for implementation of the invention according to one available embodiment.

FIG. 8 provides more details of the software organization of the platform of FIG. 7.

### SUMMARY OF THE INVENTION

This invention entails a grid service provider vendor rating system. This grid resource rating system will collect and display empirical data reflecting each vendor's actual performance against SLA, as nominally negotiated in an automated proposal process. The statistical data will be compiled into a data repository such as a database and allow organizations such as vendors, clients and new customers to access and improve internal process as needed based on the comparative figures.

### DETAILED DESCRIPTION OF THE INVENTION

Our grid service provider vendor rating system is both systematic and automated. Collected performance data is used to automatically generate ratings relative to Service Level Agreement (“SLA”) criteria, which enables clients, vendors, or the grid management processes to select resources and delegate jobs to those resources for improved compliance to SLA requirements and objectives. Furthermore, the new rating system applies a standard format to each grid vendor, and tracks SLA compliance, in our preferred embodiment. With the performance data collected and consistently and fairly analyzed, powerful reports can be produced for clients, vendors, and grid management administrators, as well.

The following definitions will be employed throughout this disclosure:
(a) “Grid” shall mean of a collection of computing resources such as servers, processors, storage systems, and communications media, ranging from just a few machines to groups of machines organized as a hierarchy potentially spanning the world;
(b) “Job” shall mean a desired requested task that a client initiates to be processed using available and selected resources;
(c) “Resources” shall mean any system, hardware or software module that is available within a grid for use in completing a job, such as application programs, hardware, software licenses, storage and related components; and
(d) “SLA” shall refer specifically to an IBM Service Level Agreement, and more generically to any documented set of client-driven criteria for job handling on a grid, including but not limited to processing accuracy, results format, processing time for completion, and cost of job processing.
   Overview of Grid Computing

As previously discussed, IBM has pioneered the development of systems, architectures, interfaces, and standards for open grid computing. As grid computing is relatively new in the field of computing, we will first provide an overview of grid computing concepts and logical processes. Additional information regarding grid computing in general is publicly available from IBM, several other grid computing suppliers and developers, a growing number of universities, as well as from appropriate standards organizations such as the Open Grids Computing Environment (“OGCE”) consortium. The following description of grid computing uses a generalized model and generalized terminology which can be used equally well to implement the invention not only in an IBM-based grid environment, but in grid environments comprised of systems and components from other vendors, as well.

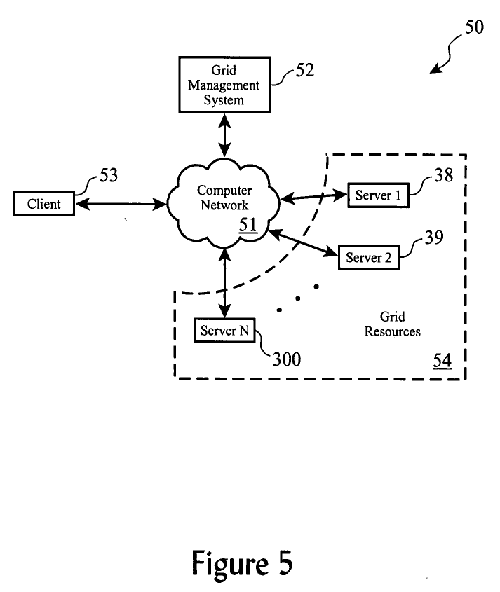

Turning to FIG. 5, the new computing paradigm of grid computing (50) is illustrated at a high level. A client (53), such as an FBI analyst using a client computer, requests a computational job or task, a cross-agency list of suspected terrorists, to be performed by the grid. The job is submitted via a communications network (51) to a Grid Management System (“GMS”), which makes a selection of which grid vendor(s) (54) to use based on client job criteria (e.g. response time, cost, accuracy, etc.) and resource characteristics, such as server capability, resource availability, storage capacity, and cost.

Once the GMS determines a specific vendor(s) (38, 39, 300) to which the job will be assigned (or among which the job will be divided), requests are sent to the selected grid resources, such as Server 1 (38). Server 1 (38) would then process the job as required, and would return job results, such as a terrorist name list, back to the requesting client (53), such as the FBI analyst, via the communications network (51).

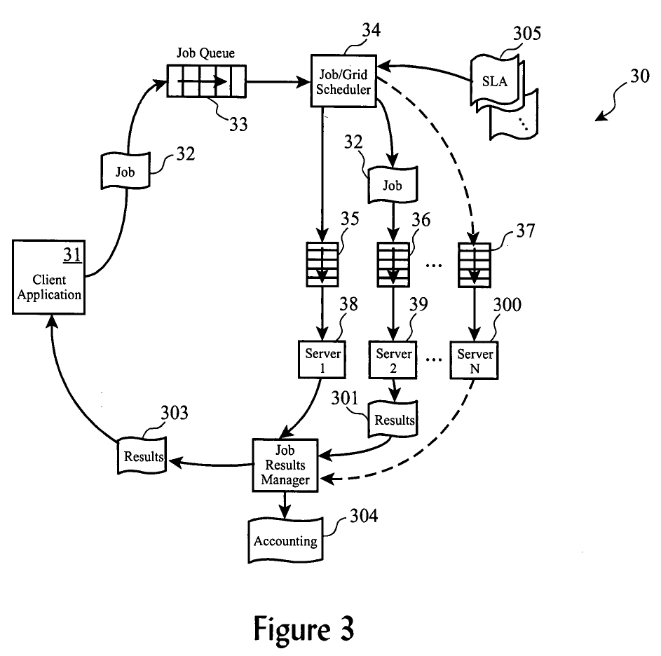

FIG. 3 provides a more detailed illustration (30) of how grid computing functions at a lower level. When a job (32) is submitted by a client application (31) to the grid, the job (32) is received into a grid inbound job queue (33), where it awaits assignment to one or more grid resources.

A Job/Grid Scheduler (“JGS”) (34) retrieves each pending job from the inbound job-queue (33), verifies handling requirements against one or more SLA (305) to determine processing requirements for the job, and then selects which server or servers (28, 29, 300) to assign to process the job (32). In this illustration, Server 2 (39) has been selected, so the job (32) is transferred to Server 2′ job queue (36) to be processed when the server becomes available (immediately if adequate processing bandwidth is already available). Some servers may handle their job queues in an intelligent manner, allowing jobs to have priority designation which allows them to be processed quicker or sooner than earlier-received, lower priority jobs.

Eventually, the assigned server completes the job and returns the results (301) to a Job Results Manager (“JRM”) (302). The JRM can verify job completion and results delivery (303) to the client application (31), and can generate job completion records (304) as necessary to achieve billing and invoice functions.

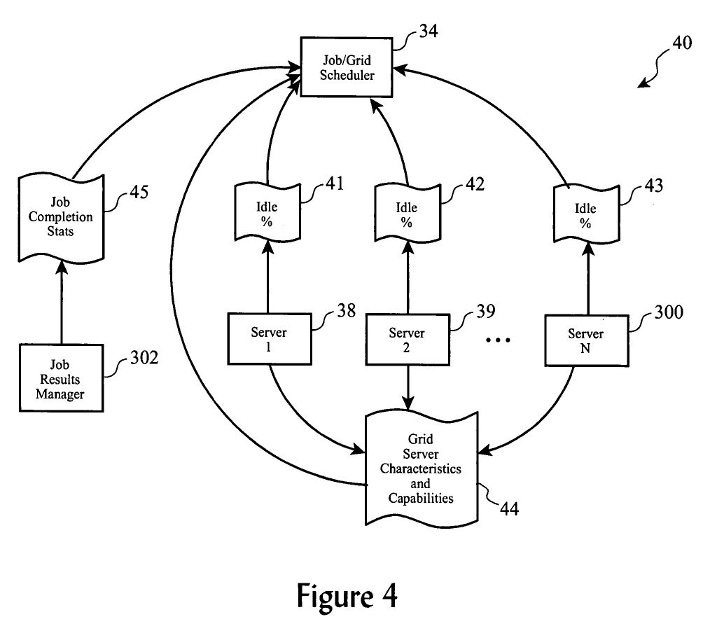

Turning now to FIG. 4, more details of the resource selection process (40) are shown. Each grid resource (38, 39, 300) may report in real-time its availability or “percent idle” (41, 42, and 43) to the Job/Grid Scheduler (34). Additionally, a set of grid resource characteristics and capabilities (44) is compiled, either statically, dynamically, or both, which is also available for the JGS (34) to use. Some server characteristics may be static, such as hardware characteristics (e.g. installed memory, communications protocols, or licenses), which other characteristics may be more dynamic in nature, such as number of licenses available for a certain application program (e.g. PDF generators, video compressors, etc.). Additionally, the completion statistics (45), from the Job Results Manager (302) are preferably available to the JGS (34), as well.

Through consideration of these factors regarding the grid resources, and in combination with the SLA client requirements, the JGS can select one or more appropriate grid resources to which to assign each job. For example, for high-priority jobs which require immediate processing, the JGS may select a resource which is immediately available, and which provides the greatest memory and processing bandwidth. For another job which is cost-sensitive but not time critical, the JGS may select a resource which is least expensive without great concern about the current depth of the queue for handling at that resource.

Grid Computing Environment Enhanced with Our Grid Vendor Rating System

As previously discussed, the present invention may be alternately realized in conjunction with a wide variety of grid computing products, resources, and clients, and is especially well suited for implementation with the IBM grid environment.

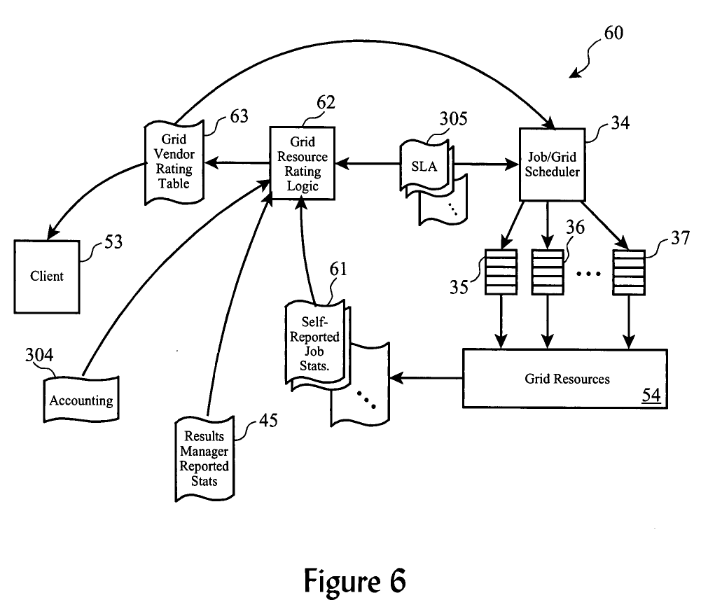

FIG. 6 illustrates a grid computing environment (60) enhanced with the processes and logical devices according to the present invention. A Grid Vendor Rating Table (“GVRT”) (63) is provided using a generation method described in the following paragraphs.

When a client (53) submits a job to the grid, the client may optionally access the Grid Vendor Rating Table (63) to review comparative and historical performance data based on client preferences such as cost, completion time, response time, availability and level of security. Thus, a client may enhance its job request to specify or request handling by a specific resource or set of resources. As the Grid Vendor Rating Table is dynamically generated and updated, the client's request become a time-relevant factor in the client's job requirements. Vendors who are aware of the availability of this table to the clients will be motivated to provide systems and resources which consistently perform to specification to increase job flow to their servers, thereby enhancing the overall performance of the grid.

According to another aspect of the present invention, the Job/Grid Scheduler is provided access to the Grid Vendor Rating Table (63) to enhance its ability to select resources which not only appear to be capable of handling the job according to the resources characteristics and the client SLA, but also according to each resource's historical performance.

In a further enhanced embodiment of the present invention, the Grid Vendor Rating Table(s) are available to both the client and the JGS such that both entities can select and screen resources which may or may not perform as desired or expected. Separate tables (not shown) may be maintained for each client, each resource, and for the JGS, allowing a variety of prioritization and factor weighting schemes to be employed to further enhance the selection process.

Grid Vendor Rating Table Generation

Our rating tables are generated by our Grid Resource Rating Logic (“GRRL”) (62) based upon data gathered from a number of potential sources. Ideally, all sources are used to generate the table, but in alternate embodiments, some sources may be eliminated or estimated.

The rating logic (62) obtains real-time data from grid resources (54) in self-reported job statistics (61), as well as statistics (45) reported from the Results Manager. Preferably, accounting information (34) may also be received by the rating logic (62) to allow it to include cost-to-performance considerations in the rating process.

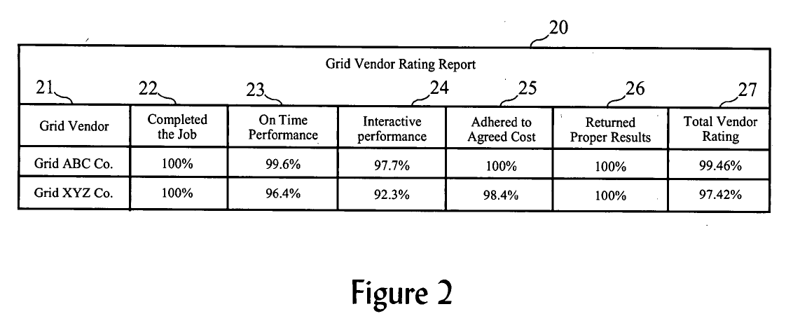

The GRRL (62) automatically compares job processing data for each job and each resource against related SLA criterion to determine if contractual agreements were met. A Grid Vendor Rating Table (43) is created containing the results of the analysis (or updated to contain the results of the most recent analysis), such as the example table shown in FIG. 2. This table may be produced in human readable form, such as in a spreadsheet file or a printed report, and is preferably provided in a machine readable format as well, such as a data file (CSV, binary, DB2, HTML, XML, etc.).

As shown in FIG. 2, an example Grid Vendor Rating Table (20) includes one or more entries (e.g. rows in this depiction), each entry representing one or more performance historical factors for a particular vendor (e.g. ABC Co. or XYZ co.) (21). Each entry has one or more fields which represent the results of a particular analysis, such as percentage of jobs completed (22), percentage of jobs completed within allowed time constraints (23), responsiveness to jobs which are interactive in nature (24), compliance to cost estimates or cost schedules (25), accuracy of results (26), and an overall or composite vendor rating (27). These are example analyses results only, and do not represent the full scope of possible results, of course.

Further, the overall vendor rating (27) is preferably determined either by an equal rating approach for all of the individual analysis results, or by applying a weighting scheme to the individual analysis results in order to prioritize certain performance characteristics as needed according to a client's requirements, or according to a grid performance objective. For example, a particular client may always prefer accuracy over cost and timeliness, and as such, the overall ratings for that client's table(s) may place greater weight on the accuracy individual analysis results when determining an overall rating for a vendor. In another example, a particular grid may be advertised or touted as a high-speed grid designed especially for time-critical jobs, and as such, the rating table(s) for that grid may place greater weight on the on time performance individual analysis results.

Other analyses, table formats, and fields within the table may optionally include:
(a) an indication of the number of jobs upon which a particular score or ranking is based;
(b) an indication of the age of the data upon which a particular score or ranking is based (e.g. current data, 30 day data, 60 day data, etc.);
(c) a ranking of each vendor relative to the other vendors included in the table; and
(d) scores broken down by application or job type, such as Online Transaction Processing (“OLTP”), batch, database, and scientific types of applications.
   Grid Vendor Rating Logic

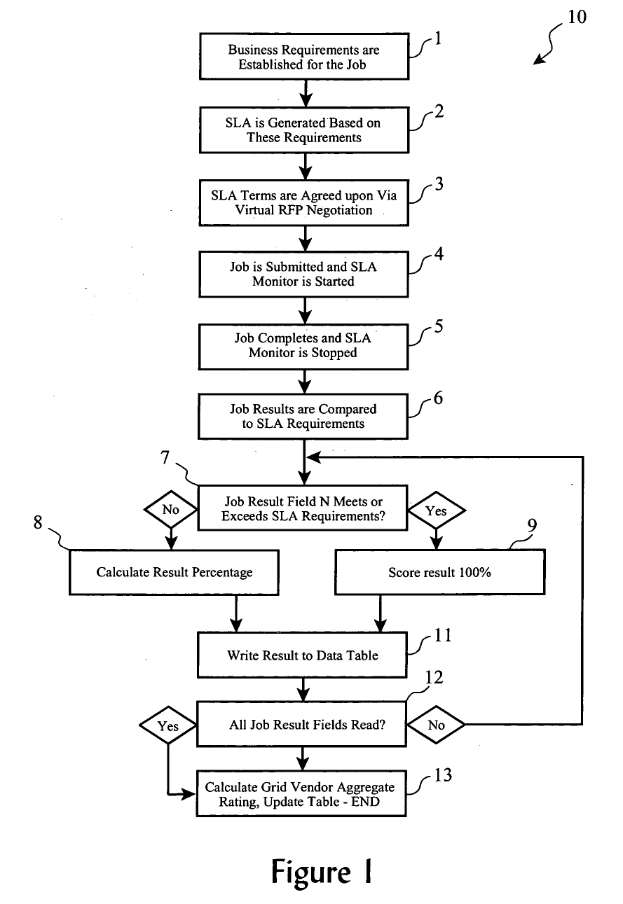

Turning now to FIG. 1, the logic (10) of the present invention is shown at a high level. This logic may be implemented in hardware, such as in programmable logic or custom integrated circuits, in software such as C or Java programs, or using a combination of both. Additionally, the logic may be centrally located, or may be distributed among two or more platforms such as servers, computers, and circuit cards.

Initially, a client establishes (1) its own set of business requirements, such as desired completion time within 24 hours with high level of security. Then, an SLA is generated (2) based on client's business requirements. The SLA agreement is then negotiated (3), preferably via a virtual Request for Proposal process, which replaces the previous manual processes for RFP submission and response.

Following establishment of an SLA, the client's job is submitted (4) and SLA monitoring begins, which tracks vendor performance statistics as previously described. When a job completes, the SLA monitoring also stops (5). The job results are compared against SLA (6), including consideration of resource self-reported statistics as previously described, to check if it meets the SLA requirements (7).

Each field of the job results is considered individually, such as a bank account statement having ending balance, average daily balance, interest accrued, and fees charged fields. If a result field meets the SLA requirement, a high score such as 100% is assigned (9) to that field. If a discrepancy is detected in the result field (e.g. accuracy was low, format was incorrect, result was out of range, etc.), then a less-than-optimal score is assigned to that field. The individual field score(s) are then saved to an intermediate table (11), and remaining job fields are processed similarly (12) until all job results fields are considered and scored.

Then, overall ratings for all fields are considered, as well as other job-specific performance information (e.g. was job completed within allowed time limits, was the cost of the job met, etc.), and a Grid Vendor Rating Table is yielded.

Any number of statistical and/or logical methods may be applied to generate the individual field scores, as indicated by the type of information and data. Likewise, a wide variety of methods for generating overall ratings of various times, as previously outlined, may be employed to generate the detailed contents of the Grid Vendor Rating table.

Computing Platform Suitable for Realization of the Invention

The invention, in one available embodiment, is realized as a feature or addition to software products, such as IBM's grid computing products, for execution by well-known computing platforms such as personal computers, web servers, and web browsers.

As the computing power, memory and storage, and communications capabilities of even portable and handheld devices such as personal digital assistants (“PDA”), web-enabled wireless telephones, and other types of personal information management (“PIM”) devices, steadily increases over time, it is possible that the invention may be realized in software for some of these devices, as well.

Therefore, it is useful to review a generalized architecture of a computing platform which may span the range of implementation, from a high-end web or enterprise server platform, to a personal computer, to a portable PDA or web-enabled wireless phone.

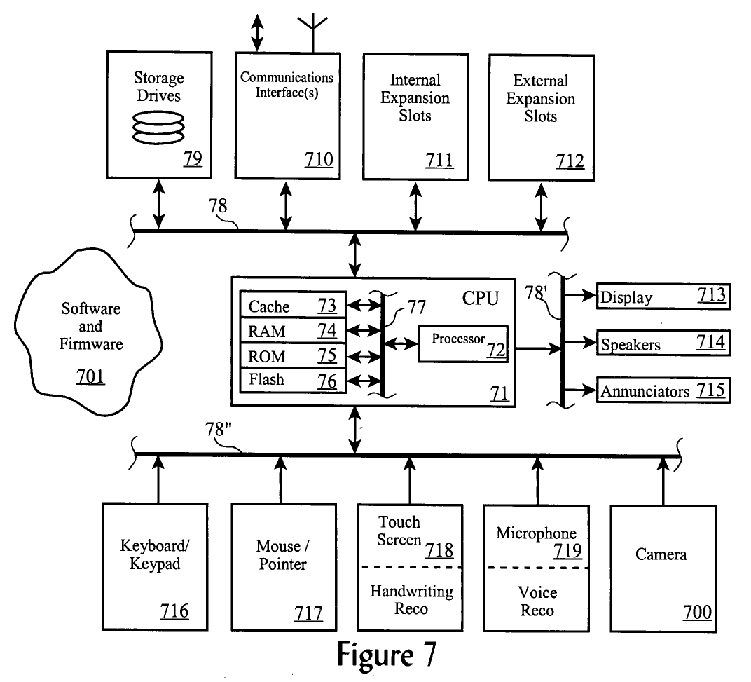

Turning to FIG. 7, a generalized architecture is presented including a central processing unit (71) (“CPU”), which is typically comprised of a microprocessor (72) associated with random access memory (“RAM”) (74) and read-only memory (“ROM”) (75). Often, the CPU (71) is also provided with cache memory (73) and programmable FlashROM (76). The interface (77) between the microprocessor (72) and the various types of CPU memory is often referred to as a “local bus”, but also may be a more generic or industry standard bus.

Many computing platforms are also provided with one or more storage drives (79), such as a hard-disk drives (“HDD”), floppy disk drives, compact disc drives (CD, CD-R, CD-RW, DVD, DVD-R, etc.), and proprietary disk and tape drives (e.g., Iomega Zip™ and Jaz™, Addonics SuperDisk™, etc.). Additionally, some storage drives may be accessible over a computer network.

Many computing platforms are provided with one or more communication interfaces (710), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (811), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (712) allowing the user the ability to easily install and remove hardware expansion devices, such as PCMCIA cards, SmartMedia cards, and various proprietary modules such as removable hard drives, CD drives, and floppy drives.

Often, the storage drives (79), communication interfaces (810), internal expansion slots (711) and external expansion slots (712) are interconnected with the CPU (71) via a standard or industry open bus architecture (78), such as ISA, EISA, or PCI. In many cases, the bus (78) may be of a proprietary design.

A computing platform is usually provided with one or more user input devices, such as a keyboard or a keypad (716), and mouse or pointer device (717), and/or a touch-screen display (718). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (718) is usually provided, often with handwriting recognition capabilities.

Additionally, a microphone (719), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (7100), such as a still digital camera or full motion video digital camera.

One or more user output devices, such as a display (713), are also provided with most computing platforms. The display (713) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (714) and/or annunciators (715) are often associated with computing platforms, too. The speakers (714) may be used to reproduce audio and music, such as the speaker of a wireless telephone or the speakers of a personal computer. Annunciators (715) may take the form of simple beep emitters or buzzers, commonly found on certain devices such as PDAs and PIMs.

These user input and output devices may be directly interconnected (78′, 78″) to the CPU (71) via a proprietary bus structure and/or interfaces, or they may be interconnected through one or more industry open buses such as ISA, EISA, PCI, etc. The computing platform is also provided with one or more software and firmware (7101) programs to implement the desired functionality of the computing platforms.

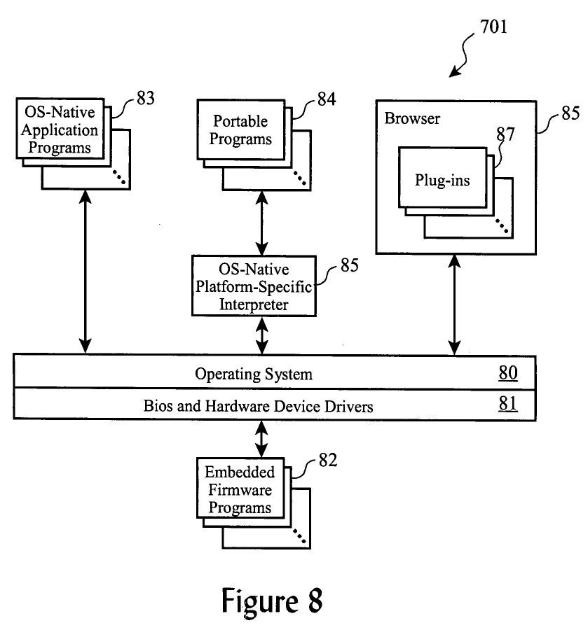

Turning to now FIG. 8, more detail is given of a generalized organization of software and firmware (7101) on this range of computing platforms. One or more operating system (“OS”) native application programs (823) may be provided on the computing platform, such as word processors, spreadsheets, contact management utilities, address book, calendar, email client, presentation, financial and bookkeeping programs.

Additionally, one or more “portable” or device-independent programs (824) may be provided, which must be interpreted by an OS-native platform-specific interpreter (825), such as Java™ scripts and programs.

Often, computing platforms are also provided with a form of web browser or micro-browser (826), which may also include one or more extensions to the browser such as browser plug-ins (827).

The computing device is often provided with an operating system (820), such as Microsoft Windows™, UNIX, IBM OS/2 ™, LINUX, MAC OS™ or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (821) are often provided to allow the operating system (820) and programs to interface to and control the specific hardware functions provided with the computing platform.

Additionally, one or more embedded firmware programs (822) are commonly provided with many computing platforms, which are executed by onboard or “embedded” microprocessors as part of the peripheral device, such as a micro controller or a hard drive, a communication processor, network interface card, or sound or graphics card.

As such, FIGS. 7 and 8 describe in a general sense the various hardware components, software and firmware programs of a wide variety of computing platforms, including but not limited to personal computers, PDAs, PIMs, web-enabled telephones, and other appliances such as WebTV™ units. It will be readily recognized by those skilled in the art that the methods and processes disclosed herein may be alternatively realized as hardware functions, in part or in whole, without departing from the spirit and scope of the invention.

Conclusion

The present invention enhances the ability of clients to request specific grid vendors who have historically performed according to a client's preferences, and enhances a grid computing control system's ability to select-grid resources and vendors for job assignment who have historically performed according to performance requirements.

It will be recognized by those skilled in the art that the foregoing examples and embodiment details are provided for illustration of the present invention, and that certain variations in embodiment may be made without departing from the spirit and scope of the present invention. Therefore, the scope of the invention should be determined by the following claims.

1. A logical device for rating the performance of one or more resource vendors in a grid computing environment, comprising:
an input for receiving one or more resource self-reports, each self-report having statistics regarding job processing;
an input for receiving one or more client-driven performance criteria definitions;
an input for receiving one or more job results from a grid resource;
an output for outputting a Grid Vendor Rating Table; and
a grid resource analyzer configured to perform an analysis of said received job results against said client-driven performance criteria and said self-reports, and configured to produce a grid resource rating table having zero or more sub-ratings, and a composite rating.

2. The system as set forth in claim 1 wherein said input for receiving one or more client-driven performance criteria definitions comprises an input for receiving a Service Level Agreement.

3. The system as set forth in claim 1 wherein said grid resource analyzer is configured to perform analysis to produce one or more sub-ratings selected from the group of percentage of jobs completed, percentage of jobs completed within specified time constraints, an interactiveness rating, a cost compliance rating, and a results accuracy rating.

4. The system as set forth in claim 1 wherein said grid resource analyzer is configured to produce a composite rating using a weighted combination of a plurality of sub-ratings.

5. The system as set forth in claim 1 wherein said grid resource analyzer is configured to produce a human-readable report.

6. The system as set forth in claim 1 wherein said grid resource analyzer is configured to produce a computer-readable report.

7. The system as set forth in claim 1 wherein said grid resource analyzer is configured to produce a rank-ordered Grid Vendor Rating Table for a plurality of resource vendors.

8. The system as set forth in claim 7 wherein said grid resource analyzer is configured to produce a rank-ordered Grid Vendor Rating Table for a plurality of resource vendors using a weighted analysis of said sub-ratings for each resource vendor.

9. The system as set forth in claim 1 further comprising a grid vendor selector configured to receive said Grid Vendor Rating Table, a job request, a set of available grid resource characteristics, and one or more client-driven performance criteria definitions, and to produce a grid vendor selection which meets said client-driven performance definitions according its grid resource characteristics, and which is indicated by said Grid Vendor Rating Table to historically meet desired performance criteria.

10. The system as: set forth in claim 1 wherein said grid resource analyzer is configured Lo produce a Grid Vendor Rating Table for a plurality of resource vendors having an indication of the age of the information upon which the table is based.

11. The system as set forth in claim 1 wherein said grid resource analyzer is configured to produce a Grid Vendor Rating Table containing an indicator of the number of jobs upon which the ranking for each resource vendor is based.

12. The system as set forth in claim 1 wherein said grid resource analyzer is configured to produce a Grid Vendor Rating Table containing one or more analysis pertaining to job types.

13. The system as set forth in claim 12 wherein said job type is selected from the group of Online Transaction Processing jobs, batch jobs, database jobs, and scientific jobs.

14. A method for automatically rating the performance of one or more resource vendors in a grid computing environment, comprising the steps of:
receiving one or more grid resource self-reports, each self-report having statistics regarding job processing;
accessing one or more client-driven performance criteria definitions;
receiving one or more job results from a grid resource; and
performing by a logical device an analysis of said job results against said client-driven performance criteria and said self-reports; and
producing a grid resource rating table having zero or more sub-ratings, and having a composite rating.

15. The method as set forth in claim 14 wherein said step of receiving one or more client-driven performance criteria definitions comprises receiving a Service Level Agreement.

16. The method as set forth in claim 14 wherein said step of performing an analysis comprises determining one or more sub-ratings selected from the group of percentage of jobs completed, percentage of jobs completed within specified time constraints, an interactiveness rating, a cost compliance rating, and a results accuracy rating.

17. The method as set forth in claim 14 wherein said step of performing an analysis comprises determining a composite rating using a weighted combination of a plurality of sub-ratings.

18. The method as set forth in claim 14 wherein said step of producing a grid resource rating table comprises producing a human-readable report.

19. The method as set forth in claim 14 wherein said step of producing a grid resource rating table comprises producing a computer-readable report.

20. The method as set forth in claim 14 wherein said step of producing a grid resource rating table comprises producing a rank-ordered Grid Vendor Rating Table for a plurality of resource vendors.

21. The method as set forth in claim 20 wherein said step of producing a rank-ordered Grid Vendor Rating Table for a plurality of resource vendors comprises producing a rank-ordered Grid Vendor Rating Table for a plurality of resource vendors using a weighted analysis of said sub-ratings for each resource vendor.

22. The method as set forth in claim 14 further comprising:
accessing said produced Grid Vendor Rating Table, a jot request, a set of available grid resource characteristics, and one or more client-driven performance criteria definitions; and
producing a grid vendor selection which meets said client-driven performance definitions according its grid resource characteristics, and which is indicated by said Grid Vendor Rating Table to historically meet desired performance criteria.

23. The method as set forth in claim 14 wherein said step of producing a Grid Vendor Rating Table comprises producing a table having an indication of the age of the information upon which the table is based.

24. The method as set forth in claim 14 wherein said step of producing a Grid Vendor Rating Table comprises producing a table having an indicator of the number of jobs upon which the ranking for each resource vendor is based.

25. The method as set forth in claim 14 wherein said step of performing an analysis of said job results against said client-driven performance criteria and said self-reports comprises performing one or more analyses pertaining to job types.

26. The method as set forth in claim 25 wherein said job type is selected from the group of Online Transaction Processing jobs, batch jobs, database jobs, and scientific jobs.

27. A computer readable medium encoded with software for automatically rating the performance of one or more resource vendors in a grid computing environment, said software performing the steps of:
receiving one or more grid resource self-reports, each self-report having statistics regarding job processing;
accessing one or more client-driven performance criteria definitions;
receiving one or more job results from a grid resource; and
performing by a logical device an analysis of said job results against said client-driven performance criteria and said self-reports; and
producing a grid resource rating table having zero or more sub-ratings, and having a composite rating.

28. The medium as set forth in claim 27 wherein said software for receiving one or more client-driven performance criteria definitions comprises software for receiving a Service Level Agreement.

29. The medium as set forth in claim 27 wherein said software for performing an analysis comprises software for determining one or more sub-ratings selected from the group of percentage of jobs completed, percentage of jobs completed within specified time constraints, an interactiveness rating, a cost compliance rating, and a results accuracy rating.

30. The medium as set forth in claim 27 wherein said software for performing an analysis comprises software for determining a composite rating using a weighted combination of a plurality of sub-ratings.

31. The medium as set forth in claim 27 wherein said software for producing a grid resource rating table comprises software for producing a human-readable report.

32. The medium as set forth in claim 27 wherein said software for producing a grid resource rating table comprises software for producing a computer-readable report.

33. The medium as set forth in claim 27 wherein said software for producing a grid resource rating table comprises software for producing a rank-ordered Grid Vendor Rating Table for a plurality of resource vendors.

34. The medium as set forth in claim 33 wherein said software for producing a rank-ordered Grid Vendor Rating Table for a plurality of resource vendors comprises software for producing a rank-ordered Grid Vendor Rating Table for a plurality of resource vendors using a weighted analysis of said sub-ratings for each resource vendor.

35. The medium as set forth in claim 27 further comprising software for performing the steps of:
accessing said produced Grid Vendor Rating Table, a job request, a set of available grid resource characteristics, and one or more client-driven performance criteria definitions; and
producing a grid vendor selection which meets said client-driven performance definitions according its grid resource characteristics, and which is indicated by said Grid Vendor Rating Table to historically meet desired performance criteria.

36. The medium as set forth in claim 27 wherein said software for producing a Grid Vendor Rating Table comprises software for producing a table having an indication of the age of the information upon which the table is based.

37. The medium as set forth in claim 27 wherein said software for producing a Grid Vendor Rating Table comprises software for producing a table having an indicator of the number of jobs upon which the ranking for each resource vendor is based.

38. The medium as set forth in claim 27 wherein said software for performing an analysis of said job results against said client-driven performance criteria and said self-reports comprises software for performing one or more analyses pertaining to job types.

39. The medium as set forth in claim 38 wherein said job type is selected from the group of Online Transaction Processing jobs, batch jobs, database jobs, and scientific jobs.
